(19) United States
(12) Patent Application Publication
(10) Pub. No.: US 2004/0040586 A1
(43) Pub. Date: Mar. 4, 2004

(54) Cleaning apparatus and method

(76) Inventor: Chandran D. Kumar, Houston, TX (US)

Correspondence Address: CHANDRAN D. KUMAR, 1506 CROCKER ST, HOUSTON, TX, 77019, US

(21) Appl. No.: 10/233,345

(22) Filed: Sep. 3, 2002

(51) Int. Cl. B08B 3/00

(52) U.S. Cl. 134/26; 134/30; 134/95.3; 134/103.2; 134/113; 134/198

(57) ABSTRACT

A cleaner cleans an implement in a controlled environment by performing a two-fold process. A preferred cleaner performs at least two treatments on the implement using one or more fluids. The fluids can include water, steam, gas, as well as detergents and sterilizing agents. A preferred cleaner includes a chamber, a boiler for generating steam, and a sprayer adapted to convey the steam from the boiler onto the implement. Another preferred cleaner includes a chamber, a fluid processor adapted to convey a fluid to the chamber, a sprayer for directing the fluid onto the implement, and a sterilizer for reducing the level of biological contaminants on the implement. The fluid processor may be an electrically driven centrifugal pump that receives a washing liquid.

### BACKGROUND

1. Field of the Invention

The present invention generally relates to an apparatus for cleaning implements. More particularly, the present invention relates to an apparatus for multi-step treatment of one or more implements in a controlled environment. Still more particularly, the present invention relates to an apparatus for washing and sterilizing an implement in a controlled environment. In a different aspect, the present invention relates to methods for placing an implement in a desired condition by performing multi-step treatments on the implement in a controlled environment.

2. Description of the Related Art

One unending task in ordinary life is the cleaning of tools, utensils, cloths, tools, and other such implements after use. In many instances, it is not simply enough to remove dirt, debris or other unwanted particles from the implement. Rather, the removal of unwanted particles is a prerequisite for one or more additional steps. For example, a tool may need to be washed before being treated with oil. Another instance is an instrument that must be dried of all moisture after washing to prevent rust. A common cleaning task that is known to many families is the washing and sterilizing of toys and utensils used by a baby. For brevity, a baby or infant bottle is used as an exemplary implement in the discussion below.

Whether immediately after birth or some time thereafter, an infant or baby bottle may be used to feed a baby certain fluids such as water, milk, juice or other liquids. Because infant bottles can be a carrier of biological contaminants, these implements are usually washed and sterilized after use. The term biological contaminant generally refers to any organisms such as germs, bacteria, or viruses that can cause illness upon exposure. Of course, nearly any illness can pose a substantial health risk to a young child. In addition to placing a child's health at risk, illness can be particularly burdensome on parents. For example, the cost of doctor visits and medication can, at times, be substantial. Moreover, a parent may be required to take time off work to attend to the child. In fact, even the sleep lost caring for a child struggling with a common cold or flu can take its toll on a parent's health. Accordingly, it is desirable reduce the instances in which a child may be exposed to illness inducing biological contaminants. Thus, it is common to sterilize an infant or baby bottle to reduce the level of these biological contaminants.

One way to clean an infant bottle is by hand. The infant bottle typically has a base, a collar and a nipple. Initially, a sink is partially filled with warm water that includes a small amount of detergent. Thereafter, the collar, base and nipple are washed with a brush or other scrubbing means. After these parts are washed, they are immersed in a vat of water that has been brought to a boil. The parts remain immersed for about fifteen minutes to one-half hour. Finally, the implements are removed from the water and dried (e.g., placed on paper towels or on a rack). This method has a number of drawbacks, a few of which are described below. First, it has been the experience of the inventor that this process can take upwards of one hour to complete. One hour, particularly during the evening time, can be valuable for nearly any parent. Second, this process inconveniently occupies the kitchen sink, counter space, and a stove burner. Because this is a daily process, the inconvenience persists as long as the baby bottles are used. Third, this process can uneconomically use a considerable amount of water; i.e., a sink full of water to wash, running tap water to rinse, and boiled water to sterilize. Because a baby may be fed eight to twelve times per day, the daily washing and sterilizing of these implements can be burdensome due to the frequency of cleanings and number of implements cleaned.

Conventional devices for cleaning of an implement are usually directed to either the washing or the sterilizing portion of the cleaning process. For example, dishwashers may be used to wash an implement. It has been the experience of the inventor, however, that dishwashers do not adequately wash baby bottles. For example, on occasion, food particles from plates or other utensils can be trapped in the parts of bottle. While the bottle can be washed separately, it can be fairly expensive to run a dishwasher to wash only four to eight bottles. Moreover, many baby bottles have somewhat narrow necks that prevent fluid such as water from reaching some portions of the interior surfaces. Additionally, conventional dishwashers typically do not provide a controlled heat setting to effectuate sterilization. It has been reported that some dishwashers may include a sterilizing cycle. It is believed, however, that such dishwasher are relatively expensive, relatively large, and not economical to run for only six to twelve bottles.

Another conventional device is a container that holds a plurality of bottles. The container is filled with some water and placed in a microwave. The microwave heats to water to boiling to thereby sterilize the bottles. This device is an alternative to the water vat but does not necessarily lessen the amount of human intervention in the cleaning process. Yet another device is a counter-top dishwasher that is connected to a water tap. While the counter-top dishwasher can wash a small number of implements, it does not provide a controlled sterilization cycle.

Other implements, in addition to baby bottles, can act as carriers for germs and viruses. For example, infants and small children often use devices such as no-spill cups (sometimes referred to as “sippy” cups), pacifiers, toys and similar items on a daily basis. Conventional devices do not provide a convenient means to wash and sterilize these items. Moreover, it is not only implements used by babies or infants that may require sterilization. Implements used by a child or adult that is ill may also require sterilization. For example, it may be desirable to sterilize the implements used by an adult having an infectious flu to limit the risk that other persons will also contract the flu. Sterilization may also be useful when a person has a reduced immunity to biological contaminants.

Other items that are not conveniently cleaned with conventional devices include cutlery, glasses, and delicate dishes (e.g., china). Some of these items may get chipped or otherwise damaged during even gentle dishwasher operation while others are best washed separately. Items such as drinking cups may require additional steps after washing to obtain a “spot-free” appearance. Still other implements include wash towels.

The present invention addresses and other drawbacks of conventional cleaning systems.

### SUMMARY OF THE INVENTION

The present invention provides a convenient cleaner for cleaning one or more implements where the cleaning is a multi-step step process. Embodiments of the present invention can be compact, portable, relatively inexpensive to manufacture, and economical to use. One embodiment of the present invention includes a portable, compact housing that defines a chamber that provides one or more implements with a controlled environment and a cleaner in fluid communication with the chamber. The cleaner performs at least two treatments on the implement using one or more fluids. These fluids can include water, steam, gas, as well as detergents and sterilizing agents. A preferred embodiment includes a chamber, a boiler for generating steam, and a sprayer adapted to convey the steam from the boiler onto the implement. In this preferred embodiment, the implement is washed and sterilized by steam. A discharge member may be used to control the pressure of the steam in the boiler. Apertures provided on the sprayer form this steam into a pre-determined pattern that enhances treatment of the implement. Moreover, the sprayer can be stationary or mobile. An exemplary mobile sprayer can include a rotating arm that is propelled by a steam jet. Advantageously, the boiler can use a dedicated or external heat source to generate this steam.

Another preferred embodiment includes a chamber, a fluid processor adapted to convey a fluid to the chamber, a sprayer for directing the fluid onto the implement, and a sterilizer for reducing the level of biological contaminants on the implement. The fluid processor may be an electrically driven centrifugal pump that receives a washing liquid, such as water, from an external source.

Additional features that can be used in conjunction with the present invention include scrubbers that cooperate with the sprayers to remove unwanted material from the implement, sensors that detect parameters of interest (e.g., chamber temperature), alarms that activate when a pre-determined condition is detected, mechanical and/or electrical interlocks that intervene when a predetermined condition is detected, and a microprocessor that control one or more aspects of operation.

Thus, the present invention comprises a combination of features and advantages that enable it to overcome the deficiencies of prior systems and methods. For example, the portable and compact nature of the embodiments enable a counter top placement and, thus, avoids the necessity of replacing existing appliances (such as dishwashers). The various characteristics described above, as well as other features, will be readily apparent to those skilled in the art upon reading the following detailed description of the embodiments of the invention, and by referring to the accompanying drawings.

It should be understood that examples of the more important features of the invention have been summarized rather broadly in order that detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

For a detailed description of an embodiment of the invention, reference will now be made to the accompanying drawings wherein:

FIG. 1 shows a schematic diagram of an embodiment of the present invention;

FIG. 2A schematically illustrates a sectional elevation of a preferred embodiment of the present invention;

FIG. 2A schematically illustrates a sectional elevation of another embodiment of the present invention that uses a separate heat source;

FIG. 3 illustrates an exemplary sprayer made in accordance with the present invention;

FIG. 4 illustrates an exemplary stem made in accordance with the present invention;

FIG. 5 schematically illustrates a sectional elevation of another preferred embodiment of the present invention;

FIG. 6 illustrates an exemplary rotating sprayer made in accordance with the present invention; and

FIG. 7 illustrates an exemplary rotating scrubber made in accordance with the present invention.

### DESCRIPTION OF THE PREFERRED EMBODIMENT

The present invention relates to devices and methods that enable the efficient treatment of implements. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein.

A cleaner made in accordance with the present invention will provide a more convenient and cost-effective method of cleaning implements than that provided by conventional devices. The term “implement” as used hereinafter refers to any object that is to be treated. For convenience, the term “cleaning” refers to the collection of steps required to bring an object to a predetermined or desired condition. The steps may be performed simultaneously or consecutively. For example, “cleaning” may involve bringing an infant bottle to a desired degree of sterilization or bringing a crystal drinking glass to a substantially “spot free” condition. As will become apparent, the present invention is amenable to numerous adaptations.

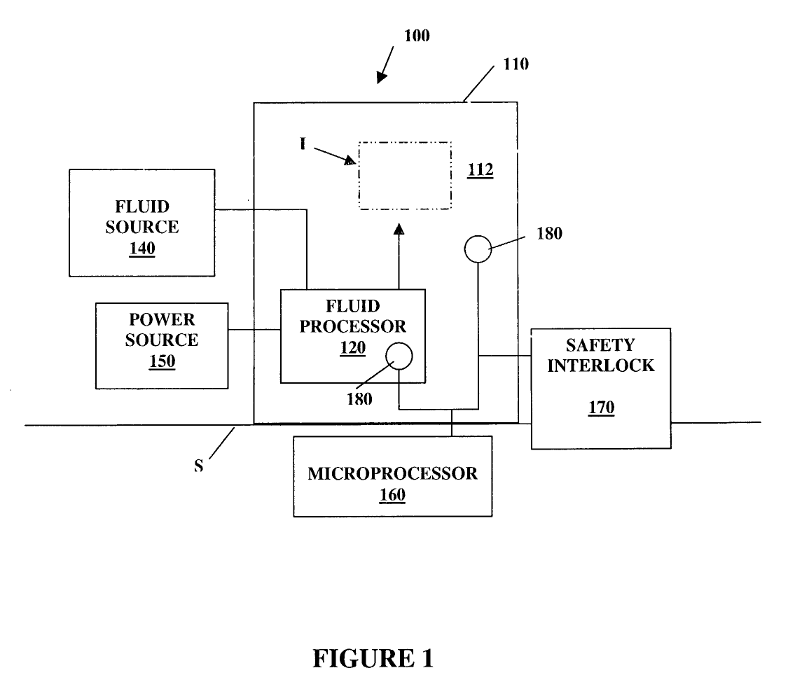

Referring initially to FIG. 1, a cleaner 100 made in accordance with the present invention includes a housing 110 and a fluid processor 120. The housing 110 has a controlled interior chamber 112 in which an implement I is placed. At least two treatments are performed by the fluid processor 120 on the implement 130 using fluid provided by a fluid source 140. These treatments can occur in separate stages or simultaneously. The fluid source 140 may be either local dedicated source or a remote source and dispense a liquid, a gas, or a mixture thereof. Moreover, two or more different fluids may be used for two or more separate treatments. Energy for the cleaner 100 can be provided by a local or remote power source 150 that uses thermal, electrical, chemical, or other known forms of energy.

The exemplary embodiment can also include an optional processor 160, an optional safety interlock 170, and optional sensors 180. These optional features can separately or cooperatively control the operation of the cleaner 100. For example, the processor 160 may be programmed to control the duration and intensity of the washing and sterilizing process. Additionally, the processor may be coupled to sensors 180 that detect chamber conditions such as humidity, pressure, and temperature and send one or more indicative signals. The processor 160 can alter the cleaner 100 operation in response to the sensor signals.

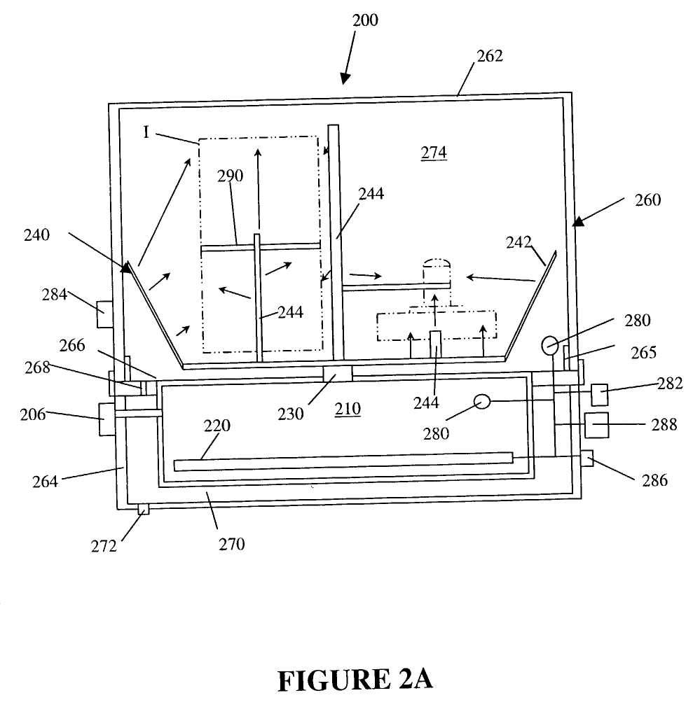

Referring now to FIG. 2A, there is shown a preferred cleaner 200 that uses steam to wash and sterilize one or more implements 1. The cleaner 200 includes a boiler 210, a heating element 220, a discharge member 230, a sprayer 240, and a housing 260. As will become apparent, the preferred cleaner 200 performs these tasks with minimal human intervention. The terms “wash,” “sterilize,” and “store” are used in their ordinary and common sense and do not imply any particular medical or clinical standards. The boiler 210 is disposed within the housing 260 of the cleaner 200. The heating element 220, which may be integral with or positioned inside the boiler 210, is preferably an electrical coil that radiates heat when energized. A liquid, such as water, is poured via a suitable inlet 206 leading into the boiler 210. Energizing the heating element 220 converts at least a portion of the liquid into a vapor such as steam. The discharge member 230 is provided on the boiler 210 to control the release of the steam or steam/liquid mixture (hereafter “steam”). A preferred discharge member 230 includes a one-way biased valve (not shown) having a spring member, a ball member, and a seat. By adjusting the spring constant of the spring member, a pre-determined amount of pressure can be induced within the boiler. When this pre-determined pressure is reached, the ball member lifts off the seat and releases the steam. Alternatively, the discharge member 230 may be a bore or passage (not shown) having a diameter that is size to induce a predetermined pressure in the boiler 210.

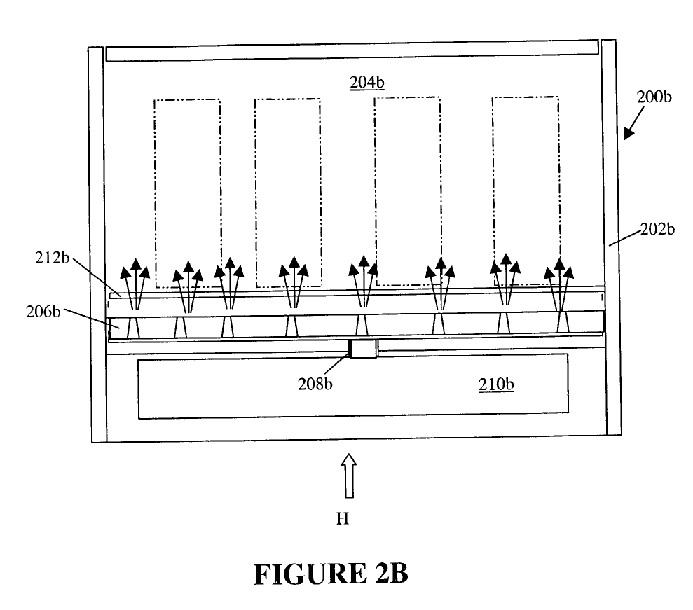

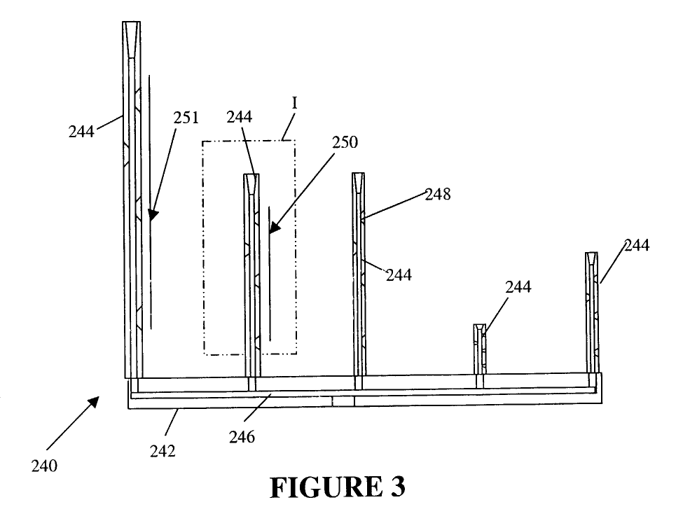

The preferred sprayer 240 sprays fluid in a pre-determined manner (e.g., velocity, spray pattern, volume, duration, degree of aeration) onto the implement. Referring now to FIGS. 3 and 4, there is shown an exemplary sprayer 240 includes an arm 242, a stem 244, a flow line 246, and an array of strategically positioned nozzles or apertures 248. The nozzles 248 may be configured to atomize (i.e., create a fine mist), pressurize, disperse the fluid or otherwise form a pre-determined flow pattern for the fluid. This pre-determined flow pattern may, for example, be formed to easily enter a reduced neck of a bottle to reach interior surfaces or maximize dispersion of fluid on an exterior surface. It will be apparent to one of ordinary skill in the art that the design of such nozzles 248 may be modified to obtain a desired property such as flow velocity. During operation, the steam travels through the flow line 246 and out of the nozzles or apertures 248 in a jet-like spray, an exemplary jet or jet spray being referred to with numeral 249. The impact of the fluid on the implement surface dislodges or otherwise removes unwanted materials such as contaminants or food particles. For simplicity, this action will generally be referred to as washing an implement or implement surface. This washing may provide a final desired level of cleanliness or some intermediate level of cleanliness. In a preferred embodiment, the sprayer 240 includes (a) a first set of nozzles 250 that direct one or more fluids such as air or water to one or more internal surfaces of the implement I; and (b) a second set of nozzles 251 that deliver one or more fluids such as air or water to one or more external surfaces of the implement 1. The sprayers 240 depicted in FIGS. 2 and 3 illustrate two variations in length and orientation of the stems 244.

Referring back to FIG. 2A, the housing 260 include a cover 262, and a base 264, a basin 266, a drain 268, a tank 270, and a discharge plug 272. The cover 262 and the base 264 define a chamber 274 that provides a controlled environment in which the implement 130 is disposed. In a particularly preferred embodiment, the housing 260 is portable and can be easily situated on a household surface such as a counter-top. For ease of access to the chamber 274, the cover 262 may be hinged to the base 264 or completely removable therefrom. Also, to minimize the flow of fluids to and from the chamber 274, the mating portions of the cover 262 and the base 264 may be provided with seals 265.

The implement I may be secured within the chamber in any number of ways. For example, the sprayer 240 can include one or more standoffs or centralizers 290 to prop up (e.g., position and secure) the implement on the stem 244. Preferably, the standoff or centralizer 290 is formed of relatively thin members that require only minimal contact with the implement surface.

Referring still to FIG. 2A, the preferred cleaner 200 may also include features to enhance operations. Such features include sensors 280, interlocks 282, an exhaust vent 284, a timer 286, and a microprocessor 288. The timer 286 controls the cleaner 200 operation by, for example, energizing the heating coil 220 for a preset duration. The safety sensors 280 can monitor parameters such as pressure, temperature, electrical flow, moisture and water level. In an advantageous arrangement, the safety sensors 280 are operably coupled to the interlock 282 such that cleaner 200 operation is interrupted or terminated upon detection of a pre-determined condition. The pre-determined condition can include excessive pressure or temperature, a fluid leak, an electrical short or other event that can compromise the operation of the cleaner 200 or cause damage or injury. Optionally, the exhaust vent 284 fixed on the cover 262 or other suitable place allows air to escape from the chamber 274 after cleaner 200 operation concludes. This vent 284 can, for example, be used to reduce the humidity in the chamber 274 using either natural or forced ventilation (e.g., an electrically driven fan). Moreover, the microprocessor 288 can be programmed to cycle the cleaner 200 through the cleaning operation and to alter operation in the event an undesirable condition is detected.

In a related alternate embodiment that is shown in FIG. 2B, a separate heat source H is used to evaporate the cleaning fluid. In the FIG. 2B embodiment, the cleaner 200b includes a housing 202b, a chamber 204b, a sprayer 206b, a discharge member 208b, and a passive boiler 210b. The passive boiler 210b is a kettle-like container that is filled with a liquid. A burner of a conventional stove or microwave oven H is used to generate the steam in the passive boiler 210b. To allow this stearn to access the implement I surfaces, a grill or basket 212b may be used in lieu of a centralizer to secure the implements in the chamber 204b. As can be appreciated, the use of a separate heat source thereby eliminates the need for the heating coil and related equipment.

Presuming familiarity with above described embodiment, the following description of operation dispenses with the use of numerals. During use, one or more implements are positioned within the chamber and the cover is placed on the base to provide a substantially closed environment for the implement. Upon activation, the heating coils boil the water in the boiler to create steam. This steam is brought to a pre-determined condition (e.g., pressure) by the discharge member. The steam released from the boiler flow through the sprayer. The nozzles or apertures of the sprayer direct a steam jet onto the inner and outer surfaces of the implement. The steam jet removes unwanted debris, dirt, or other particles from the implement. The heat associated with the steam jet also sterilizes the implement. The steam condenses on the implement surfaces and interior of the cover and base. This condensation drips onto the basin, flows through the drain, into the tank, and is evacuated via the discharge plug. It should be noted that the steam jet may be sufficient to dislodge unwanted particles from the implement surfaces without detergents. Because the chamber has a substantially closed environment, the implements can remain in the chamber after sterilization. If present, the optional vent may be activated to reduce the moisture content of the chamber.

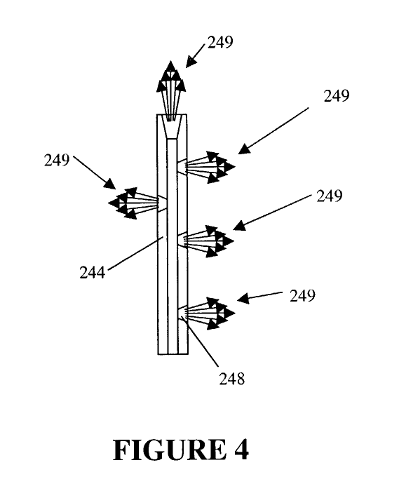

Referring now to FIG. 5, another preferred cleaner 500 made in accordance with the present invention includes a housing 510, a pump 550, and a heater 570. The preferred cleaner 500 is configured to wash, sterilize and store in a controlled environment one or more implements. The preferred cleaner 500 may be used in a convention kitchen having a water tap, a sink and an electrical outlet.

The housing 510 includes a cover 512, a chamber 514, and a base 516. The cover 512 is preferably made of a high-density plastic that can withstand exposure to elevated temperatures, water, and detergent type of chemicals. The cover 512 may include features such as a double wall construction or an insulation layer to limit the radiation of heat or the escape of moisture from within the housing 510 during operation. A handle 513 may be provided for easy hand manipulation. The cover 512 is formed to seat on the base 516 and can include a clamp (not shown) to secure the cover 512 to the base 516. A seal (not shown), such an elastomeric o-ring, can be used reduce the flow or fluids between the cover 512 and the base 516. The chamber 514 is formed within the cover 512 and is adapted to receive one or more implements (e.g., an infant bottle). Upon seating the cover 512 onto the base 516, the chamber 514 provides a relatively sealed environment wherein the implement may be washed, sterilized and stored.

A preferred configuration for the base 516 includes a sprayer 522, a basin 524, and a drain 526. The sprayer 522 is generally the same as that described with respect to FIGS. 2-4 and, therefore, will not be described. The basin 524 collects the fluid that drips or flows off the implement and the drain 526 and conveys the fluid to a discharge hose 528. The discharge hose 528, which is connected to the base 516 with a substantially watertight fitting, directs the fluid into the sink.

The implement may be held within the chamber with the centralizer 290 shown in FIG. 2A or, as shown in FIG. 5, with an arm 529 having a spring-like “C” portion In any event, the present invention is not limited to any particular arrangement for securing an implement.

The pump 550 provides a fluid to the sprayer 522 at a pre-determined condition (e.g., pressure, velocity, water content). The pump 550 is conveniently positioned within the base 516. The pump 550 has an inlet portion 552 that receives fluid from the supply hose 529, and an outlet portion 554 that discharges fluid into the fluid lines of the sprayer 522. A valve 556 may be interposed between the supply hoses and the inlet portion 554 to selectively provide fluid to the pump 550. For example, the valve 556 may be a biased one-way check valve. The valve 556 may also selectively vary the type of fluid entering the pump 550. For example, the valve 556 may switch from water to air. The pump 550 is preferably a centrifugal pump that is driven by an electric motor (not shown). Such pumps are well known in the art and will not be discussed in detail. Optionally, the pump 550 can operate with either continuous fluid or continuous air. This optional pump may provide a cleaning fluid (e.g., water) for cleaning action in a first mode and circulate a drying fluid (e.g., air) in a second mode.

The heater 570 heats the chamber 514 to a pre-determined temperature. A preferred heater 570 is positioned within the chamber 514 and elevates the air temperature to a pre-determined point. For example, the heater 570 may induce a temperature that sterilizes a desired portion of the implement I. By sterilized, it is meant that the level of biological contaminants such as germs is reduced such that the biological contaminants do not pose a reasonable threat of infection. The heater 570 includes a thermal element 572 and a timer 574. The thermal element 572 is connected to an electrical supply (not shown) and is energized by the timer 574 for a pre-determined amount of time. The timer 570 may be preset or adjustable. Alternatively, the heater 570 may be positioned adjacent the pump 550. In such a configuration, the heater 570 may heat the air entering or exiting the pump 550. In an alternate embodiment, the heater 570 is configured to heat the cleaning fluid to a temperature suitable for sterilization.

The preferred cleaner 500 may also include a dispenser 580 for adding a detergent into the washing fluid. The dispenser 580 may be a tray that is positioned either before or after the pump 550. The dispenser 580 can hold a detergent that is in a convenient liquid or granular form. The detergent can be metered into the fluid by a metering device (not shown) or added into the fluid using a timer (not shown). For example, a metering device and timer can cooperate to add the detergent from the dispenser 580 into the fluid after a predetermined time during which the implement is rinsed; i.e., the surfaces are wetted.

During use, the preferred cleaner is connected to a power supply (e.g., electrical outlet) and a fluid supply (e.g., water tap). After, one or more implements is positioned within the chamber, the cover is placed on the base to provide a substantially closed environment for the implement. Upon activation, the nozzles direct a fluid stream onto the inner and outer surfaces of the implement. The fluid cleaning the surfaces drips onto the basin and through the drain for discharge to a sink. Thereafter, the heater elevates the air temperature of the chamber to a level that provides a desired amount of sterilization. Because the chamber has a substantially closed environment, the implements can remain in the chamber after sterilization. In an alternate mode of operation, the heater operates concurrently with the pump to provide sterilizing heat during the cleaning process. It should be appreciated that concurrent operation will advantageously increase the heat of the fluid. Of course, if the heater can also be used to heat the washing fluid to a point that promotes sterilization. In still another alternate embodiment, the heater may be used to bring the washing fluid to a steam state while the fluid travels from the pump to the nozzles. The steam or steam/water mixture leaving the nozzle may provide enhanced washing action coupled with sterilization.

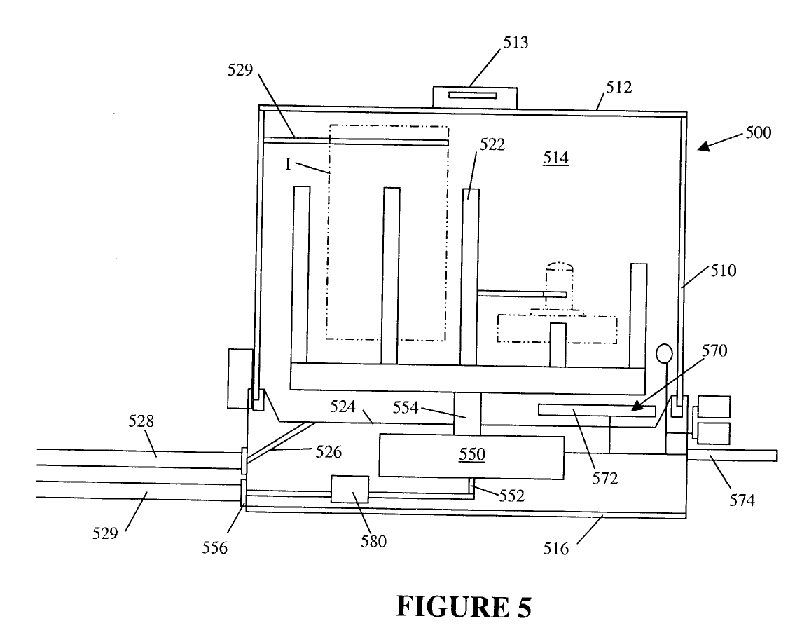

It should be understood that the described sprayers are merely one arrangement adapted to deliver fluids to an implement interior and exterior. Referring now to FIG. 6, there is shown a rotating sprayer 600 having arms 602 radiating from a fluid distribution hub 604. The arms have nozzles or apertures 606 that direct fluid onto the implement. One or more nozzles 610 are arranged such that the flow of fluid propels the arms 602 to thereby rotate the sprayer 700. The selection of a particular sprayer configuration will be influenced by such factors as the available velocity of the fluid stream, the type of fluid, the shape and texture of the implement to be cleaned, and type of debris or contaminants to be removed. For example, if the implement is an infant bottle, the particles will generally be the remnants of simple fluids such as milk, juice and water. Typically, the foods ingested by infants via a bottle do not include solids. Usually, the solids that are mixed into a base fluid such as milk are a cereal such as rice cereal or oatmeal. These solids generally do not require a vigorous washing action for removal. These solids, however, can clog small orifices such as those in the dispenser nipples for infant bottles. Accordingly, the fluid stream directed to these small orifices should provide a relatively more vigorous washing action. It should be appreciated that the sprayer system may have a plurality of nozzles or apertures, sets of which are configured to provide different predetermined levels of washing action.

It will be appreciated that the present invention may be adapted to make advantageous use of presently available and future cleaning, sterilizing and storing technologies. For example, numerous alternatives may be used to kill or otherwise neutralizes biological contaminants. For instance, a sterilizing agent that kills common biological contaminants, such as alcohol, may be used instead or in addition to sterilizing heat. The agent may be a liquid stored in a tank and selectively fed either directly or into the chamber. The sterilizing agent may also be radiation emitted by a source positioned adjacent the chamber. Additionally, the sterilizing agent may be a sterilizing gas that is selectively released either directly or indirectly into the Chamber. The sterilizing agent, regardless of the form, may be applied either concurrent with the washing process or sequentially with the washing process.

In another embodiment, the cleaner includes a reservoir for holding clean and used washing fluid, thereby eliminating the need for a connection to a water source. The reservoir can include a first compartment for clean fluid and a second compartment for fluid that has been circulated. The pump is preferably modified to provide the pressure needed to circulate the clean and used fluid.

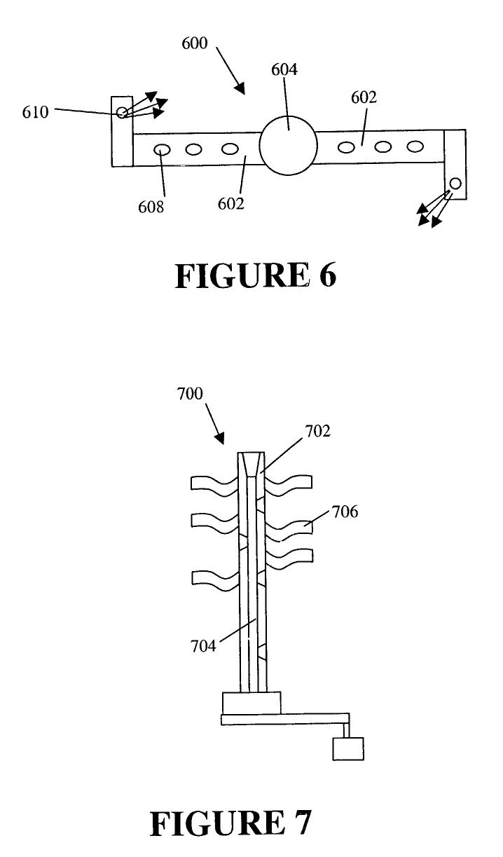

Referring now to FIG. 7, there is shown rotating stems 700 are used to clean the implement surfaces. The rotating stems include nozzles 702, a bore 704, and a plurality of scrubbing members 706 that frictionally contact the implement surface. The stems 700 are rotated by a suitable system such as an electric motor coupled to a belt or gear drive. The scrubbing members 706 can include but are not limited to bristles, foam, synthetic or natural fibers, and paper strips. Further, the scrubbing members 806 may be either disposable or reusable.

Moreover, the general arrangement may be modified to accommodate any number of uses. The preferred cleaner is portable and has external dimensions that can be accommodated or a conventional kitchen countertop. However, certain facilities, such as day care centers, clean a number of implements on a daily basis. Aspects of the present invention may be advantageously applied to such situations by making a large capacity washing apparatus that accommodates a relatively larger number of implements. It will be apparent that the large capacity washing apparatus may not be easily stored on a kitchen surface.

In other embodiments, the present invention may be used to clean implements such as no-spill cups, pacifiers, toys, and eating utensils. It will be appreciated that the chamber interior can be easily modified to accommodate nearly implement configuration. Indeed, the housing may be formed as a modular unit having, for example, an interchangeable cover. A first cover can be adapted for receiving infant bottles, a second cover can be adapted for holding cups and pacifiers and a third cover can be adapted to hold forks, spoons, knives and plates. The modular housing thereby increases the service life of an exemplary washer made in accordance with the present invention.

The cleaner may also be operated in any number of modes. For example, in a rinse mode, the cleaner can simply apply a fluid that rinses the implement surface. In a sterilization mode, the cleaner can initiate only the sterilization for the implements.

The present invention may also be used to clean certain household instruments that require washing and sterilization. Examples include components of breast pumps and devices used to administer medication. Toothbrushes and other implements intended for hygienic purposes may also require washing and sterilization in certain circumstances. Indeed, clothing such as hand towels and bibs may also be cleaned with the present invention. The modification needed to accommodate such implements will be apparent to one of ordinary skill in the art.

In a different aspect, the present invention may also be used to clean mechanical parts (e.g., bolts, screws, washers). An embodiment directed to this application can, for example, apply a degreaser wash the part with steam, dry the part using heated air, and then apply a rust inhibiting coating. Likewise, an embodiment of the present invention can also be adapted to clean household items such as jewelry, eyeglasses, and sunglasses. Indeed, the simplicity of the present invention may be adapted to uses not discussed, such as the preparation of food.

The foregoing descriptions directed to particular embodiments of the present invention for the purpose of illustration and explanation. It will be apparent, however, to one skilled in the art that many modifications and changes to the embodiment set forth above are possible without departing from the scope and the spirit of the invention. It is intended that the following claims be interpreted to embrace all such modifications and changes.

I claim:

1. An apparatus for cleaning an implement, comprising:
a chamber for providing a controlled environment for the implement;
a boiler for generating steam; and
a sprayer in fluid communication with said boiler, said sprayer adapted to convey the steam from said boiler onto the implement in a pre-determined condition, whereby the implement is such substantially washed and substantially sterilized by the steam.

2. The apparatus of claim (1) wherein said boiler is energized by one of an external heat source and an internal heat source.

3. The apparatus of claim (1) wherein said boiler is energized by a heating member that radiates heat when an electrical current is applied thereto.

4. The apparatus of claim (1) wherein said sprayer comprises a plurality of apertures that form the steam into a jet having a pre-determined pattern.

5. The apparatus of claim (1) further comprising a discharge member associated with said boiler, said discharge member controlling the pressure of the steam generated by said boiler.

6. The apparatus of claim (1) wherein said sprayer comprised a rotating arm having at least one aperture for forming the steam into a jet, the steam jet thereby causing said rotating arm to rotate.

7. An apparatus for cleaning an implement, comprising:
a portable housing;
a chamber formed in said housing, said chamber providing a controlled environment for the implement;
a fluid processor adapted to convey a fluid to the chamber;
a sprayer in fluid communication with said fluid processor, said spray directing the fluid onto the implement, said implement being substantially washed by the fluid; and
a sterilizer disposed in said housing for reducing the level of biological contaminants on the implement to a predetermined level, the implement thereby being substantially sterilized.

8. The apparatus of claim (7) wherein said fluid processor comprises an electrically driven pump.

9. The apparatus of claim (7) wherein said sterilizer comprises one of a heat source, a chemical source, and a radiation source.

10. The apparatus of claim (8) wherein said sprayer includes a rotating scrubber for removing unwanted material from the implement.

11. The apparatus of claim (7) wherein the fluid is water.

12. The apparatus of claim (7) wherein said sterilizer comprises a dispenser in fluid communication with said chamber, said dispenser selectively releasing a sterilizing agent into said chamber for substantially sterilizing the implement.

13. The apparatus of claim (7) further comprising a microprocessor for controlling the operation of said fluid processor and said sterilizer.

14. The apparatus of claim (7) further comprising a sensor for monitoring a condition in the chamber, said sensor transmitting a signal when the condition is detected; and an alarm connected to the sensor that is energized upon receiving said signal from the sensor.

15. An method for cleaning an implement, comprising:
providing a portable housing having a chamber for providing a controlled environment for the implement; and
washing the implement with a first fluid; and
sterilizing the implement with a second fluid.

16. The method of claim (15) further comprising scrubbing an interior surface of the implement.

17. The method of claim (15) further comprising directing a steam jet onto a surface of the implement, the jet having a pre-determined pattern.
